(19) United States
(12) Patent Application Publication
(10) Pub. No.: US 2008/0320311 A1
(43) Pub. Date: Dec. 25, 2008

(54) APPARATUS AND METHOD FOR AUTHENTICATING FIRMWARE

(75) Inventor: Ki-seon CHO, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Suwon-si (KR)

(21) Appl. No.: 11/964,809

(22) Filed: Dec. 27, 2007

(30) Foreign Application Priority Data
Jun. 20, 2007 (KR) 2007-60684

(51) Int. Cl. H04L 9/00

(52) U.S. Cl. 713/187; 380/277

(57) ABSTRACT

An apparatus and method to authenticate firmware stored in a firmware storage unit. The apparatus includes a controller to commands an authenticator to start firmware authentication, the authenticator, which performs authentication of the firmware using a signature read from the firmware storage unit, and a bus controller to controls a data transmission bus to a decoder. The authenticator prevents data from being transmitted through the data transmission bus if the firmware authentication fails, and the authenticator controls the bus controller to enable data to be transmitted through the data transmission bus if the firmware authentication succeeds. Using the apparatus, illegal use of content can be prevented.

### CROSS-REFERENCE TO RELATED APPLICATION

This application claims the benefit of Korean Application No. 2007-60684, filed in the Korean Intellectual Property Office on Jun. 20, 2007, the disclosure of which is incorporated herein by reference.

### BACKGROUND OF THE INVENTION

1. Field of the Invention

Aspects of the present invention relate to an apparatus and method for authenticating firmware, and more particularly, to an apparatus and method to authenticate firmware for preventing illegal use of content by hacking the firmware, by performing firmware authentication in hardware.

2. Description of the Related Art

With the advent of high definition (HD) DVD drives and Blu-ray optical disc drives to handle HD content, the advanced access content system (AACS) has been applied as a method of protecting the HD content. The AACS has recently been compromised (hacked), however, and the AACS association is searching for a method to strengthen the AACS. One of the methods includes preventing illegal hacking a drive's firmware. The prevention of illegal hacking of firmware is a function required in most apparatuses for reproducing content, and various methods of supporting such a function are being researched.

While performing conventional firmware authentication in software manner, the firmware authentication cannot be performed when the firmware authentication is performed using a firmware authentication program recorded on the flash memory with the firmware and the flash memory is subsequently replaced. When a program for firmware authentication is included in firmware, the program itself can be hacked. Further, when the program is included in the firmware, the size of the firmware increases, and thus a large capacity memory is required.

### SUMMARY OF THE INVENTION

Aspects of the present invention provide an apparatus and method for authenticating firmware to prevent illegal use of content by hacking the firmware, by performing firmware authentication in hardware.

According to an aspect of the present invention, an apparatus to authenticate firmware stored in a firmware storage unit is provided. The apparatus includes an authenticator to perform the firmware authentication of the firmware using a signature read from the firmware storage unit; a controller to command the authenticator to start firmware authentication; and a bus controller to control a data transmission bus to a decoder, wherein the authenticator prevents data from being transmitted through the data transmission bus if the firmware authentication fails, and the authenticator controls the bus controller to enable data to be transmitted through the data transmission bus if the firmware authentication succeeds.

According to another aspect of the present invention, the authenticator may perform firmware authentication of the firmware using at least one authentication method from among an elliptic curve digital signature algorithm (ECDSA), a Rivest-Shamir-Adlemen (RSA), an advanced encryption standard (AES), and a message authentication code (MAC).

According to another aspect of the present invention, the authenticator closes the data transmission bus or transmits an error message to the data transmission bus in order to prevent data from being transmitted through the data transmission bus if the firmware authentication fails.

According to another aspect of the present invention, the authenticator authenticates the firmware using a portion of the firmware data.

According to another aspect of the present invention, the apparatus further includes a content storage unit to store content, wherein the authenticator controls the bus controller to enable the content read from the content storage unit to be transmitted to the decoder if the firmware authentication succeeds.

According to another aspect of the present invention, the apparatus further includes an optical disk inserter in which an optical disk is inserted, wherein the authenticator controls the bus controller to enable content read from the optical disk to be transmitted to the decoder if the firmware authentication succeeds.

According to another aspect of the present invention, the apparatus further includes a memory card slot in which an attachable memory card is inserted, wherein the authenticator controls the bus controller to enable content read from the memory card to be transmitted to the decoder if the firmware authentication succeeds.

According to another aspect of the invention, the decoder is included in the apparatus.

According to another aspect of the invention, the controller commands the authenticator to start the firmware authentication when power is applied to the apparatus.

According to another aspect of the invention, the apparatus is an optical disk drive.

According to another aspect of the present invention, a method of authenticating firmware is provided. The method includes reading firmware and a signature for authenticating the firmware from a storage unit; authenticating the firmware using the signature; preventing data from being transmitted through a data transmission bus to a decoder if the authentication fails; and enabling data to be transmitted through the data transmission bus if the authentication succeeds.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an apparatus for authenticating firmware, according to an embodiment of the present invention;

FIG. 2 is a diagram illustrating a structure of a flash memory including firmware, according to an embodiment of the present invention;

FIG. 3 is a block diagram illustrating an apparatus for authenticating firmware, according to another embodiment of the present invention;

FIG. 4 is a flowchart illustrating processes of manufacturing a memory in which firmware is stored, according to an embodiment of the present invention;

FIG. 5 is a flowchart illustrating a method of authenticating firmware in an apparatus for authenticating firmware, according to an embodiment of the present invention; and

FIG. 6 is a flowchart illustrating in detail the method of authenticating firmware of FIG. 5, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

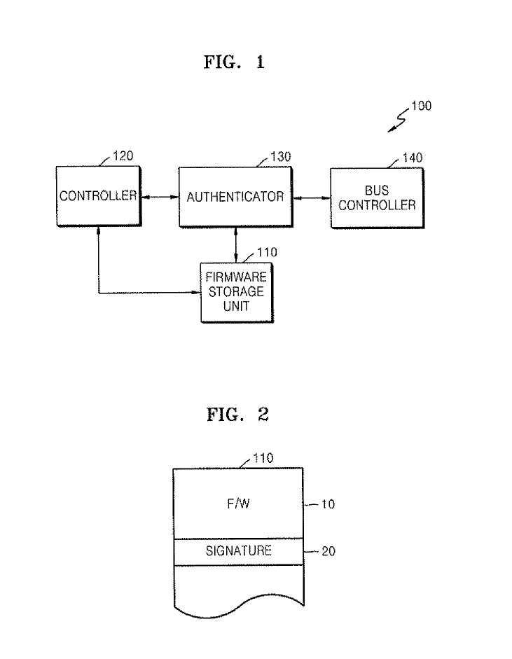

FIG. 1 is a block diagram illustrating an apparatus 100 for authenticating firmware, according to an embodiment of the present invention. The apparatus 100 includes a firmware storage unit 110, a controller 120, an authenticator 130, and a bus controller 140. According to other aspects of the invention, the apparatus may include additional and/or different units. Similarly, the functionality of one or more of the above units may be integrated into a single component.

The apparatus 100 may be formed of a front end (F/E) chip of an optical disk drive, such as a DVD, Blu-ray, or HD-DVD drive. The apparatus 100 may also be realized as an optical disk or an apparatus for reproducing content stored in another storage medium. In addition, the apparatus 100 may be applied in various apparatuses having an interface function that requires controlling data transmission, such as general electric devices, personal computers, home servers, personal digital assistants (PDAs), portable multimedia players (PMPs), mobile phones and other mobile devices, and portable optical disk reproducers.

As used herein, firmware denotes a program required to read and/or reproduce data recorded in an internal memory (not shown) of the apparatus 100. The firmware can be realized in various forms, based on an embodiment of the apparatus 100. For example, when the apparatus 100 for authenticating firmware is an optical disk drive formed of a content reproducer for reading and reproducing content from a storage medium, such as a memory card or an internal memory, the firmware may be a program to transmit content read from the storage medium to a reproduction module, such as a decoder of the content reproducer.

The firmware storage unit 110 stores firmware including a signature. FIG. 2 is a diagram illustrating a structure of a flash memory including firmware, which is an example of the firmware storage unit 110 according to an embodiment of the present invention. As shown in FIG. 2, the flash memory includes a firmware storage area 10 and a signature storage area 20. Firmware data is recorded in the firmware storage area 10. A signature, which is recorded for firmware authentication by a firmware distributor, is recorded in the signature storage area 20. The firmware storage unit 110 may also store other kinds of data according to other aspects of the present invention.

When power is applied to the apparatus 100, the controller 120 initializes the hardware by reading the firmware data from the firmware storage unit 110. The controller 120 then commands the authenticator 130 to start firmware authentication by reading a command for starting firmware authentication from the firmware data. Firmware authentication may be performed whenever the apparatus 100 is initialized by receiving power, and thus safety of the firmware authentication can be increased.

The authenticator 130 is a hardware device that performs the firmware authentication using the signature. The authenticator 130 may be realized as a circuit for performing the firmware authentication using at least one authentication method, such as an elliptic curve digital signature algorithm (ECDSA), a Rivest-Shamir-Adleman (RSA), an advanced encryption standard (AES), and a message authentication code (MAC). Processes of authenticating the firmware will be described later with reference to FIGS. 4 through 6.

The bus controller 140 controls a data transmission bus to a decoder (not shown). The data transmission bus is a transmission path for transmitting content, which is read from a storage medium located in an external or internal drive of the apparatus 100 for authenticating firmware, to the decoder. The form or type of the data transmission bus is not limited. The decoder may be installed inside or outside the apparatus 100. In the case of an optical disk reproducer, the decoder may be to a back end unit.

If the firmware authentication is deemed by the authenticator 130 to have failed, the authenticator 130 prevents data from being transmitted through the data transmission bus. If the firmware authentication is successful, the authenticator 130 controls the bus controller 140 to enable data to be transmitted through the data transmission bus. If the firmware authentication fails, the authenticator 130 may prevent the data from being transmitted by closing the data transmission bus or transmitting an error message to the data transmission bus. If the authenticator 130 authenticates the firmware, the authenticator 130 may authenticate only a portion of the firmware data instead of authenticating the entire firmware data in order to reduce a system load by reducing the amount of processed data.

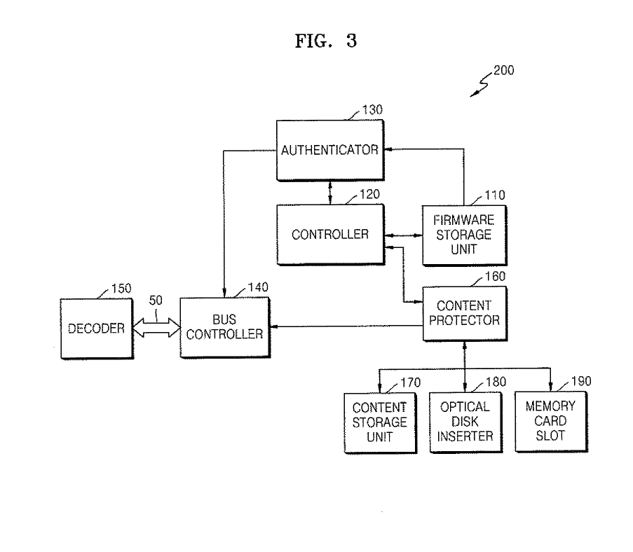

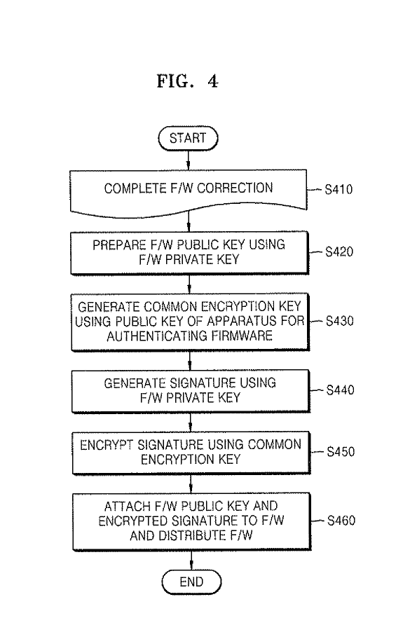

FIG. 3 is a block diagram showing an apparatus 200 for authenticating firmware, according to another embodiment of the present invention. The apparatus 200 includes a decoder 150, a content protector 160, a content storage unit 170, an optical disk inserter 180, a memory card slot 190, and a data transmission bus 50, in addition to the firmware storage unit 100, the controller 120, the authenticator 1301 and the bus controller 140. The apparatus 200 operates as a content reproducer, wherein content can be decoded and reproduced. The apparatus 200 may also include a network unit (not shown) to receive content via a wired or wireless network. The optical disk inserter 180 (or optical disk reproducing apparatus), the memory card slot 190, and the network unit may be seen as aspects of a receiving unit from which the apparatus 200 receives the content. Moreover, the apparatus 200 may both record and reproduce content.

The decoder 150 is a device corresponding to the decoder described with reference to the apparatus 100 shown in FIG. 1. The decoder 150 decodes and outputs content transmitted through the data transmission bus 50, which is controlled by the bus controller 140. The content protector 160 is a functional unit, in which an application for protecting content operates. For example, in order to protect content recorded in a DVD, the content protector 160 performs a content scrambling system (CSS), and in order to protect content recorded in an HD DVD or BD, the content protector 160 applies an advanced access contents system (SACS).

The content storage unit 170 is a memory in which content is stored. An optical disk, such as a CD, a DVD, a BD, or an HD DVD, may be installed in the optical disk inserter 180, A memory card, such as a compact flash (CF), a smart media (SM), a secure digital (SD), a memory stick (MS), or a multimedia card (MMC), may be inserted into the memory card slot 190. The content storage unit 170, the optical disk inserter 180, and the memory card slot 190 can be selectively included in the apparatus 200 such that the apparatus 200 need not include all such devices and may include other content storage devices instead of, or in addition to, the devices shown. In addition, a device (not shown) for reading content from another type of storage medium may also be included in the apparatus 200. The content may also be received via a wired or wireless network.

When power is applied to the apparatus 200, the controller 120 initializes hardware based on firmware data read from the firmware storage unit 110, and transmits a command to the authenticator 130 to start firmware authentication. The authenticator 130 then performs the firmware authentication by reading a signature and the firmware data. During the firmware authentication, a portion of the firmware data may be used instead of the entire firmware data in order to reduce a system load by reducing the amount of processed data. This is because it can be determined that the firmware has been hacked when only a portion of the firmware data is changed. For example, only even or odd data of the firmware data may be verified, or succeeding data after skipping a certain amount of bytes (for example, 8 bytes or 16 bytes) can be used in the firmware authentication. Alternatively, only a certain amount of firmware can be verified using a separate algorithm.

The bus controller 140 controls the data transmission bus 50 connecting the content protector 160 to the decoder 150 according to the control of the authenticator 130. The bus controller 140 may be realized as a switching circuit for controlling the data transmission bus 50.

If the firmware authentication fails, the authenticator 130 prevents data from being transmitted through the data transmission bus 50. The authenticator 130 may intercept the data by closing the data transmission bus 50 or by transmitting an error message to the data transmission bus 50. When the error message is received, the decoder 150 does not process data transmitted through the data transmission bus 50, since the firmware authentication has failed.

If the firmware authentication succeeds, the authenticator 130 controls the bus controller 140 to enable the data transmission bus 50 to operate normally. When the data transmission bus 50 operates normally, the controller 120 reads content recorded in the content storage unit 170, in an optical disk inserted in the optical disk inserter 180, in a memory card inserted in the memory card slot 190, or via a network, and transmits the content to the bus controller 140 based on the stored firmware. The authenticator 30 opens the data transmission bus 50, and thus the content can be transmitted and processed in the decoder 150 normally.

FIG. 4 is a flowchart showing processes of manufacturing a memory in which firmware is stored, according to an embodiment of the present invention. FIG. 4 also shows processes of the firmware distributor distributing firmware to enable firmware authentication to be performed using an ECDSA. The processes described with reference to FIG. 4 may be performed using the apparatus 100 or 200. In operation S410, the firmware distributor completes preparation or revision of the firmware. The firmware is then compiled and recorded in the firmware storage unit 110, which is installed in the apparatus 100 or 200.

In operation S420, the firmware distributor prepares a firmware public key using a firmware private key. Operation S420 can be expressed as Equation 1 below.

Kfpub=G*Kfpri (Equation 1)

Here, Kfpub denotes the firmware public key, G denotes a general parameter, and Kfpri denotes the firmware private key.

In operation S430, the firmware distributor generates a common encryption key using a public key of the apparatus 100 (or the apparatus 200). The apparatus 100 or 200 may be a driver of an apparatus for reproducing an optical disk. Operation S430 can be expressed in Equation 2 below.

Kce=Kdpub*Kfpri (Equation 2)

Here, Kce denotes the common encryption key, Kdpub denotes the public key of the apparatus 100 or 200, and Kfpri denotes the firmware private key. Kdpub denotes G (public parameter)*Kdpri (private key of the apparatus) as in Equation 1 above.

In operation S440, a signature is generated using the firmware private key. Operation S440 can be expressed as Equation 3 below.

Signf=ECDSA_SIGN(Kfpri, F/W) (Equation 3)

Here, Signf denotes the signature ECDSA_SIGN denotes a signature generation function of the ECDSA, and F/W denotes the firmware prepared or revised in operation S410.

In operation S450, the signature is encrypted using Kce (the common encryption key). Operation S450 can be expressed as Equation 4 below.

Signef=encryption(Kce, Signf) (Equation 4)

Here, Signef denotes the encrypted signature, encryption denotes an encryption function using a key, and Signf denotes the signature.

In operation S460, the firmware is distributed by attaching the Kfpub (the firmware public key) and the Signef (encrypted signature) to the firmware to encrypt the firmware or selected portions thereof. When the processes of distributing the firmware are completed, the firmware, the signature, and the firmware public key are included in the firmware storage unit 110. Moreover, it is understood that such distribution can be through a network such as where a firmware update is performed.

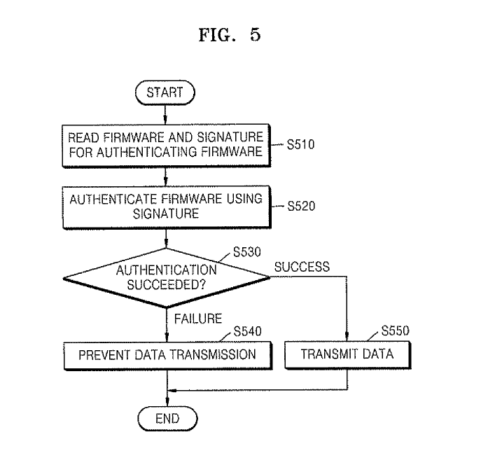

FIG. 5 is a flowchart of a process of authenticating firmware in an apparatus for authenticating firmware, according to an embodiment of the present invention. The process may be performed using the apparatus 100 or 200, or other apparatus for authenticating firmware. In operation S510, the authenticator 130 reads firmware and a signature for firmware authentication from the firmware storage unit 110. In operation S520, the authenticator 130 authenticates the firmware using the signature.

In operation S530, it is determined whether the firmware authentication is successful. If the firmware authentication fails, the authenticator 130 prevents data from being transmitted through a data transmission bus to a decoder in operation S540. If the firmware authentication succeeds, the authenticator 130 enables the data to be transmitted through the data transmission bus in operation S550.

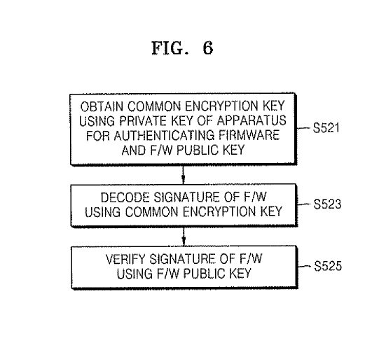

FIG. 6 is a flowchart showing in detail the process of authenticating firmware of FIG. 5. When firmware generated by a firmware distributor through the processes illustrated in FIG. 4 is authenticated, operation S520 of FIG. 5 may be performed via the sub-operations shown in FIG. 6.

In operation S521, the authenticator 130 obtains the common encryption key Kce using the private key of the apparatus Kdpri 100 or 200. The private key Kdpri of the apparatus 100 or 200 is recorded in a predetermined storage area of the authenticator 130, and the firmware public key Kfpub is recorded in the firmware storage unit 110. Operation S521 can be expressed as Equation 5 below.

Kce=Kfpub*Kdpri (Equation 5)

Here, Kce denotes the common encryption key, Kfpub denotes the firmware public key, and Kdpri denotes the private key of the apparatus.

In operation S523, the authenticator 130 decodes a signature of the firmware using Kce. Operation S523 can be expressed as Equation 6 below.

Signf=decryption(Kce, Signef) (Equation 6)

Here, Signf denotes the signature, decryption denotes a decoding function using a key, and Signef denotes an encoded signature.

In operation S525, the authenticator 130 verifies the signature using the firmware public key. Operation S525 can be expressed as Equation 7 below.

Verify_{—}rit=ECDSA_VERIFY(Kfpub, Signf, F/W) (Equation 7)

Here, Verify_rlt denotes the result of verifying the signature, ECDSA_VERIFY denotes a signature verification function of an ECDSA, Kfpub denotes the firmware public key, and Signf denotes the signature decoded using Kce.

If the signature is verified, the authenticator 130 controls the bus controller 140 in order to open a data transmission bus. If the signature fails to be verified, the authenticator 130 closes the data transmission bus.

Aspects of the present invention may also be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, DVDs, magnetic tapes, floppy disks, and optical data storage devices. The computer readable recording medium can also be distributed over network coupled computer systems so that the computer readable code is stored and executed in a distributed fashion

According to aspects of the present invention, firmware authentication is performed in a hardware manner, and content is transmitted through a data transmission bus to a decoder only when the firmware authentication is successful. Accordingly, illegal use of the content, which is the ultimate aim of a hacker, can be prevented.

In addition, even when a flash memory itself is replaced, an authenticator, which is a separate hardware element of the apparatus, performs the firmware authentication, and thus absolute safety can be guaranteed.

In addition, according to aspects of the present invention, the capacity of the firmware is not increased, and thus the content can be safely reproduced while preventing content hacking, through firmware authentication using a memory having a small capacity.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to authenticate firmware stored in a firmware storage unit, the apparatus comprising:
an authenticator to perform firmware authentication of the firmware using a signature read from the firmware storage unit;
a controller to command the authenticator to start the firmware authentication; and
a bus controller to control a data transmission bus through which data passes to a decoder,
wherein the authenticator prevents data from being transmitted through the data transmission bus if the firmware authentication fails, and the authenticator controls the bus controller to enable data to be transmitted through the data transmission bus if the firmware authentication succeeds.

2. The apparatus of claim 1, wherein the authenticator performs firmware authentication of the firmware using at least one authentication method from among an elliptic curve digital signature algorithm (ECDSA), a Rivest-Shamir-Adleman (RSA), an advanced encryption standard (AES), and a message authentication code (MAC).

3. The apparatus of claim 1, wherein the authenticator closes the data transmission bus or transmits an error message to the data transmission bus in order to prevent data from being transmitted through the data transmission bus if the firmware authentication fails.

4. The apparatus of claim 1, wherein the authenticator authenticates the firmware using a portion of the firmware without using a remaining portion of the firmware.

5. The apparatus of claim 1, further comprising:
a content storage unit to store content;
wherein the authenticator controls the bus controller to enable the content read from the content storage unit to be transmitted to the decoder if the firmware authentication succeeds.

6. The apparatus of claim 1, further comprising:
an optical disk inserter in which an optical disk is inserted;
wherein the authenticator controls the bus controller to enable content read from the optical disk to be transmitted to the decoder if the firmware authentication succeeds.

7. The apparatus of claim 1, further comprising:
a memory card slot in which an attachable memory card is inserted;
wherein the authenticator controls the bus controller to enable content read from the memory card to be transmitted to the decoder if the firmware authentication succeeds.

8. The apparatus of claim 1, further comprising the decoder to decode the data transmitted through the data transmission bus.

9. The apparatus of claim 1, wherein the controller commands the authenticator to start the firmware authentication when power is applied to the apparatus.

10. The apparatus of claim 1, wherein the apparatus is an optical disk drive.

11. A method of authenticating firmware, comprising:
reading firmware and a signature for authenticating the firmware from a storage unit;
authenticating the read firmware using the read signature;
preventing data from being transmitted through a data transmission bus to a decoder if the authentication fails; and
enabling data to be transmitted through the data transmission bus if the authentication succeeds.

12. The method of authenticating firmware of claim 11, wherein the authentication of the firmware is performed using at least one authentication method from among an elliptic curve digital signature algorithm (ECDSA), a Rivest-Shamir-Adleman (RSA), an advanced encryption standard (AES), and a message authentication code (MAC).

13. The method of authenticating firmware of claim 111 wherein the preventing of the data from being transmitted through the data transmission bus comprises closing the data transmission bus or transmitting an error message to the data transmission bus.

14. The method of authenticating firmware of claim 11, wherein the authentication of the firmware is performed using a portion of the firmware without using a remaining portion of the firmware.

15. The method of authenticating firmware of claim 11, wherein the enabling of the data to be transmitted when the authenticating the firmware succeeds comprises transmitting content read from one of an internal content storage unit, an optical disk, and a memory card to the decoder through the data transmission bus.

16. The method of authenticating firmware of claim 11, wherein the authentication of the firmware begins when power is applied to an apparatus performing the firmware authentication.

17. An apparatus to authenticate firmware, the apparatus comprising:
a bus controller to control a data transmission bus over which content is transmitted; and
an authenticator to authenticate the firmware based on a signature and to control the bus controller to allow or deny transmission of the content via the data transmission bus based on the result of the authentication.

18. The apparatus of claim 17, further comprising a controller to control the authenticator to begin the authentication when the apparatus starts up.

19. The apparatus of claim 17, further comprising:
a firmware storage unit to store the signature and the firmware;
wherein the authenticator reads the firmware and the signature from the firmware storage unit.

20. The apparatus of claim 17, further comprising:
a decoder to receive the content via the data transmission bus and to decode the content for display on a display unit;
a content protector to store a content protection application.

21. A method of distributing firmware, comprising:
preparing a firmware public key based on a firmware private key;
generating a common encryption key based on a public key of an apparatus that will authenticate the firmware;
generating a signature of the firmware based on the firmware private key;
encrypting the signature using the common encryption key; and
distributing the firmware by attaching the firmware public key and the signature to the firmware.

22. A method of authenticating firmware distributed by the method of claim 21, the method comprising:
generating the common encryption key using a private key of an apparatus authenticating the firmware;
decoding the signature using the common encryption key; and
verifying the signature using the firmware public key.
